(19) United States
(12) Patent Application Publication
(10) Pub. No.: US 2023/0300770 A1
(43) Pub. Date: Sep. 21, 2023

(54) METHOD AND APPARATUS FOR DELAY INDICATION

(71) Applicant: Lenovo (Beijing) Limited, Beijing (CN)

(72) Inventors: Hongmei Liu, Changping District (CN); Zhi Yan, Xicheng District (CN); Yuantao Zhang, Dongcheng District (CN); Bingchao Liu, Changping District (CN); Haiming Wang, Xicheng District (CN)

(73) Assignee: Lenovo (Beijing) Limited, Beijing (CN)

(21) Appl. No.: 18/041,460

(22) PCT Filed: Aug. 21, 2020
(86) PCT No.: PCT/CN2020/110507

§ 371 Date: Feb. 13, 2023

(51) Int. Cl. H04W 56/00

(52) U.S. Cl. CPC H04W 56/0045

(57) ABSTRACT

Embodiments of the present application are directed to a method and apparatus for delay indication. The method may include: receiving at least one signaling indicating at least one of a timing advance (TA) and a time domain difference between reception on a downlink (DL) channel and transmission on an uplink (UL) channel; and determining the at least one of the TA and the time domain difference based on the at least one signaling.

### TECHNICAL FIELD

Embodiments of the present application generally relate to wireless communication technology, and especially to a method and apparatus for delay indication.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), satellite and high-altitude platforms may be utilized as relay devices in communications related to ground devices such as user equipment (UE). Network or segment of network using radio frequency (RF) resources on board a satellite or an airborne aircraft may be referred to as a non-terrestrial network (NTN). In an NTN network, some or all functions of a base station (BS) may be deployed in a satellite or an airborne aircraft.

However, there is large propagation delay(s) in the NTN network due to the high attitude of satellites. Thus, how to indicate to a UE the delay(s) between a downlink (DL) channel and an uplink (UL) channel and timing advance (TA) needs to be considered.

### SUMMARY OF THE APPLICATION

Embodiments of the present application provide a method and apparatus for delay indication, e.g., between a DL channel and an UL channel and TA in a NTN network.

An embodiment of the present application provides a method. The method may include: receiving at least one signaling indicating at least one of a TA and a time domain difference between reception on a DL channel and transmission on an UL channel; and determining the at least one of the TA and the time domain difference based on the at least one signaling.

In an embodiment of the present application, the transmission on the UL channel is after the reception on the DL channel. The TA or the time domain difference is one value or multiple values shared by multiple UEs. In the case that the TA or the time domain difference is the multiple values, one of the multiple values is further indicated.

In an embodiment of the present application, the value or the one of the multiple values is indicated by at least one of radio resource control (RRC) signaling and medium access control (MAC) control element (CE) signaling

In another embodiment of the, present application, the value or the one of the multiple values is indicated by a group common downlink control information (DCI).

In another embodiment of the present application, the value or the one of the multiple values is indicated by a UE specific DCI. In an example, the value or the one of the multiple values is indicated by at least one added bit in the UE specific DCI compared with legacy UE specific DCI. In another example, the value or the one of the multiple values is indicated by using time domain resource assignment field in the UE specific DCI. In yet another example, the value or the one of the multiple values is indicated by using physical downlink shared channel (PDSCH) to hybrid automatic repeat request (HARQ) feedback timing indicator in the UE specific DCI.

In an embodiment of the present application, the method may further include: receiving a signaling indicating relationship between the TA or the time domain difference and random access channel (RACH) resource. In an example, the TA or the time domain difference is one value or multiple values shared by multiple UEs, and the value or the one of the multiple values is indicated by using physical random access channel (PRACH) mask index in the UE specific DCI. In another example, the TA or the time domain difference is one value or multiple values shared by multiple UEs, and method further includes: reporting the value or one of the multiple values by selection of RACH resource for PRACH transmission.

In an embodiment of the present application, the value or the one of the multiple values is indicated by using TA command in random access response (RAR) or MAC CE signaling.

In an embodiment of the present application, the value of the TA or the time domain difference is predefined or broadcasted in system information block (SIB). In an example, the value is applied to the time domain difference between 2-step RACH RAR and physical uplink control channel (PUCCH) transmission. In another example, the value is applied to a time duration between RACH retransmissions. In another example, the value is applied to a minimum time between Msg.B RAR and PUSCH transmission. In another example, the value is applied to minimum time between Msg.4 RAR and PUCCH transmission. In another example, the value is applied to a gap between non-zero power channel state information-reference signal (NZP CSI-RS) and sounding reference signal (SRS) for non-codebook based physical uplink shared channel (PUSCH) transmission.

In an embodiment of the present application, the signaling indicates at least one value and is based on misalignment between transmission(s) in the DL channel and reception(s) in the UL channel at a base station side and the reception on the DL channel is after the transmission on the UL channel at a user equipment side.

In an embodiment of the present application, the value is indicated by at least one of the following: SIB, RRC signaling, MAC CE signaling, and group common DCI.

In an embodiment of the present application, a first value of the at least one value is an initial value, and a second value is a change rate dependent on time of the first value.

In an embodiment of the present application, the at least one signaling is applied to MAC CE activation delay.

In another embodiment of the present application, the at least one signaling is applied to time domain duration between beam failure recovery (BFR) PRACH transmission and PDCCH monitoring.

In another embodiment of the present application, the at least one signaling is applied to time domain duration between configured grant based PUSCH transmission and PDCCH monitoring.

Another embodiment of the present application provides a method. The method may include: determining at least one of a TA and a time domain difference between reception on a DL channel and transmission on an UL channel; and transmitting at least one signaling indicating the at least one of the TA and the time domain difference between the reception on the DL channel and the transmission on the UL channel.

Another embodiment of the present application provides an apparatus. The apparatus may include at least one non-transitory computer-readable medium having computer executable instructions stored therein; at least one receiver; at least one transmitter; and at least one processor coupled to the at least one non-transitory computer-readable medium, the at least one receiver and the at least one transmitter. The computer executable instructions are programmed to implement the above method with the at least one receiver, the at least one transmitter and the at least one processor.

The embodiments of the present application can at least solve the technical problem concerning on how to indicate to the UE at least one the scheduling delay, the feedback delay and TA corresponding to multiple reference points and how to indicate to the UE a UL to DL timing relationship (U to D delay) for transparent payload due to misalignment between DL transmitting (Tx) and UL receiving (Rx) at a network side (e.g., a BS network side).

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 a schematic diagram illustrating an exemplary wireless communication system according to some embodiments of the present application;

FIG. 2 is an example illustrating an impact of propagation delay to the scheduling or feedback delay and TA;

FIG. 3 is an example illustrating different geographical areas of a cell of a satellite in which multiple reference points exist;

FIG. 4 is an example illustrating a misalignment between transmission(s) in DL channel and reception(s) in UL channel at a BS side and an impact on transmission(s) in UL channel to reception(s) in DL channel delay at a UE side;

FIG. 5 is a flow chart illustrating an exemplary method for delay indication in NTN network according to embodiments of the present application;

FIG. 6 illustrates an apparatus according to some embodiments of the present application; and

FIG. 7 illustrates an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G (NR), 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

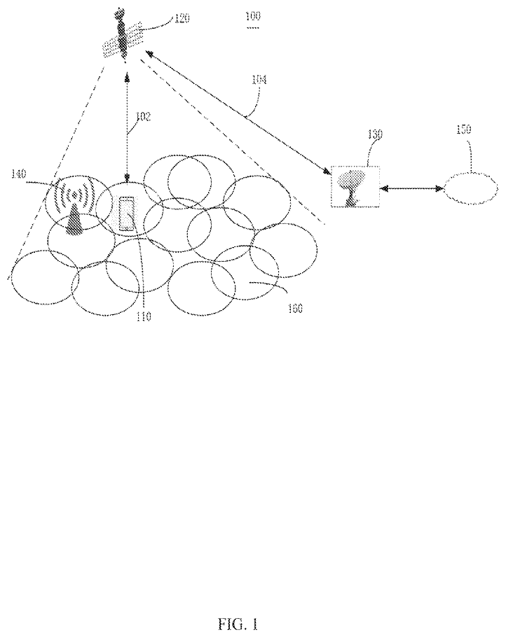

FIG. 1 is a schematic diagram illustrating an exemplary wireless communication system according to some embodiments of the present application.

Referring to FIG. 1, the shown exemplary wireless communication system is an exemplary NTN network 100 in which the techniques, processes and methods described herein can be implemented, in accordance with various embodiments of the present application. In other embodiments of the present application, the wireless communication system may be other type of networks.

Generally, to extend the coverage and availability of wireless communication systems, some or all functions of a BS may be deployed in a satellite. That is, in the NTN network, a satellite may be also referred to as a BS. For example, a satellite may generate beams over a certain service area, which may also be referred to as a cell coverage area. The concept of cell with respect to a terrestrial BS may similarly apply to a satellite serving as a BS. Such network or segment of network using RF resources on board a satellite or an airborne aircraft may be referred to as an NTN network. Hereafter, the BS(s) illustrated in the specification all cover any type of devices with the substantial function of a BS, including a satellite 120, a terrestrial BS 140 or the like.

As shown in FIG. 1, the NTN network 100 includes at least one UE 110 and at least one satellite 120. The UE(s) 110 communicates with the satellite 120 over a service link 102, which has both an uplink from the UE 101 to the satellite 120 and a downlink from the satellite 120 to the UE 110. The UE(s) 110 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present disclosure, the UE(s) 110 may include a portable wireless communication device, a smart phone, a cellular telephone, a flip phone, a device having a subscriber identity module, a personal computer, a selective call receiver, or an other device that is capable of sending and receiving communication signals on a wireless network. In some embodiments of the present disclosure, the UE(s) 110 includes wearable devices, such as smart watches, fitness bands, optical head-mounted displays, or the like. Moreover, the UE(s) 110 may be referred to as a subscriber unit, a mobile, a mobile station, a user, a terminal, a mobile terminal, a wireless terminal, a fixed terminal, a subscriber station, a user terminal, or a device, or described using other terminology used in the art.

Satellite(s) 120 may include low earth orbiting (LEO) satellites, medium earth orbiting (MEO) satellites, geostationary earth orbiting (GEO) satellites, as well as highly elliptical orbiting (HEO) satellites. In some embodiments of the present application, alternatively, a satellite 120 may be an unmanned aircraft systems (UAS) platform. The UAS platform(s) may include tethered UAS and lighter than air (LTA) UAS, heavier than air (HTA) UAS, and high altitude platform (HAP) UAS.

The satellite 120 may provide a plurality of geographic areas (footprint) 160 for serving UEs 110 located in one or more of the geographic areas. A geographic area 160 can be associated with a cell, and can also be associated with a beam. When the geographic area 160 is associated with a cell, it can be named as a “cell footprint.” When the geographic area 160 is associated with a beam, it can be named as a “beam footprint.” In FIG. 1, exemplary UE(s) may be a normal mobile terminal, which can wirelessly communicate with the satellite 120 via a communications link, such as service link or radio link in accordance with a NR access technology (e.g., a NR-Uu interface). As also shown in FIG. 1, the satellite 120 may also communicates with a gateway 130 or an on earth (terrestrial) BS 140 via a communication link, which may be a feeder link 102 or radio link in accordance with NR access technologies or other technologies. In accordance with various embodiments, the satellite 120 may be implemented with either a transparent or a regenerative payload. When the satellite 120 carries a transparent payload, it performs only radio frequency filtering, frequency conversion and/or amplification of signals on board. Hence, the waveform signal repeated by the satellite is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload, all or part of base station functions (e.g., a gNB, eNB, etc.) are implemented on board.

The gateway 130 may be coupled to a data network 150 such as, for example, the Internet, terrestrial public switched telephone network, mobile telephone network, or a private server network, etc. The gateway 130 and the satellite 120 communicate over a feeder link 120, which has both a feeder uplink from the gateway to the satellite 120 and a feeder downlink from the satellite 120 to the gateway 130. Although a single gateway 130 is shown, some implementations will include more gateways, such as five, ten, or more.

One or more terrestrial BSs 140 (i.e., not airborne or spaceborne) are provided within a typical terrestrial communication network, which provides geographical radio coverage, wherein the UEs 110 that can transmit and receive data within the radio coverage (cell coverage) of the terrestrial BS 140. In the terrestrial communication network, a terrestrial BS 140 and a UE 110 can communicate with each other via a communication link, e.g., via a downlink radio frame from the terrestrial BS 140 to the UE 110 or via an uplink radio frame from the UE 110 to the terrestrial BS 140.

Although a limited number of UEs 110 and satellites 120 etc., are illustrated in FIG. 1, it is contemplated that the wireless communication system 100 may include any number of UEs 110, satellites 120, and/or other network components.

According to some embodiments of the present application, a scheduling delay between a DL channel and a UL channel (such as a delay between PDCCH and PUSCH), a feedback delay between a DL channel and a UL channel (such as a delay between PDSCH and PUCCH) and a TA for a UL transmission will be impacted by a propagation delay between a satellite (such as, the satellites 120 in FIG. 1) and a UE (such as, the UE 110).

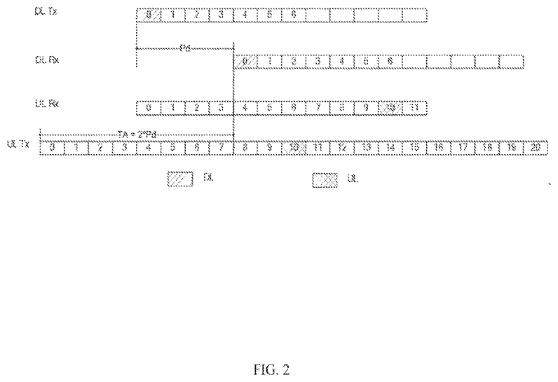

FIG. 2 is an example illustrating an impact of a propagation delay to the scheduling delay or feedback delay and TA.

As shown in FIG. 2, a BS transmits a transmission (DL Tx) in symbol #0, and the UE receives the transmission (DL Rx) in symbol #0; and then the UE transmits a feedback or a PUSCH (UL Tx) in symbol #10, and the BS receives the feedback or the PUSCH (UL Rx) in symbol #10. In FIG. 2, it assumes that the processing delay in the UE is 2 symbols, the propagation delay (“Pd” in FIG. 2) is 4 symbols, and thus round trip delay (RTD) between the satellite and the UE is 8 symbols. As shown in FIG. 2, TA=2*Pd=8 symbols, and the scheduling delay or feedback delay is 2+8=10 symbols.

According to some embodiments of the present application, a geographical area (footprint) generated by a satellite is always large, and the propagation delay difference between different UEs (such as a UE nearby the satellite and a UE far away from the satellite) may be multiple symbols.

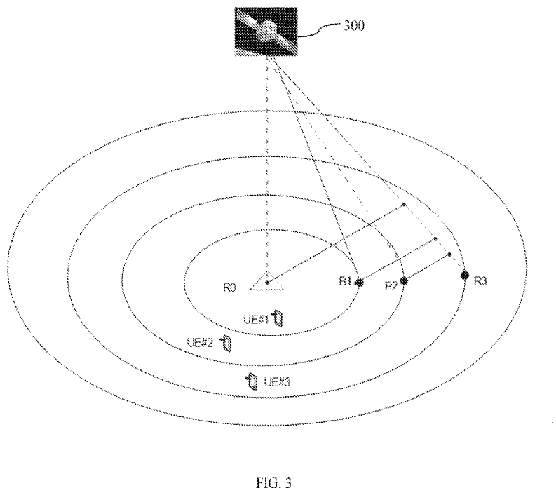

FIG. 3 is an example illustrating different geographical areas of a cell of a satellite 300 in which multiple reference points exist. The reference point may be a geographic location associated with a satellite, which can be a virtual location or an actual location. As shown in FIG. 3, there are multiple reference points, i.e., R0, R1, R2, and R3. In an example, a reference point may be a projection position of a satellite to the ground (such as R0 in FIG. 3). In another example, a reference point may be a position of a satellite. In yet another example, a reference point may be a pre-defined position (such as R1, R2, and R3 in FIG. 3). The scheduling delay or the feedback delay and the TA may be determined by a UE based on an associated reference point. For example, the TA may include two parts: common TA (which is a TA commonly configured per geographic area, and has been used in TS 38.821) and differential TA. The common TA depends on the distance between the BS e.g., a satellite and a reference point. The differential TA depends on the UE's location within the geographical area.

As shown in FIG. 3, the UE in different geographical areas of a cell may have different RTDs. For example, RTD of UE #1, RTD of UE #2, and RTD of UE #3 are different from each other.

The satellite may transmit the positions of the multiple reference points to the UEs (such as, UE #1, UE #2, and UE #3 in FIG. 3), or transmit a position of a specific reference point of the multiple reference points to a corresponding UE.

However, there is no technical solution on how to indicate to the UE the scheduling delay or the feedback delay and TA corresponding to a specific reference point of the multiple reference points. In addition, compared with the case without a reference point, the signaling overhead of the scheduling or feedback delay and TA needs to be saved in the case with reference point(s).

In another aspect, transparent payload is supported in the future. As discussed above, when a satellite carries a transparent payload, it performs only radio frequency filtering, frequency conversion and/or amplification of signals on board.

For the transparent payload, a UE can know its own position and the position of the satellite, but does not know the distance between the satellite and a ground station (e.g., a ground BS). When calculating the TA, the UE may only calculate a part of the delay. Thus misalignment between transmission(s) in DL channel and reception(s) in UL channel (such as, frame, slot, or symbol boundary) at gNB side will be unavoidable.

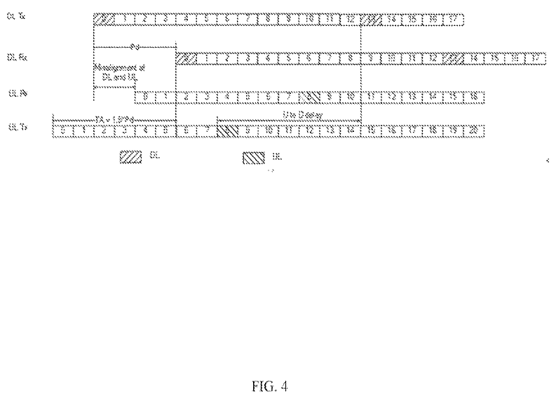

FIG. 4 is an example illustrating a misalignment between transmission(s) in DL channel and reception(s) in UL channel at a BS side and an impact on transmission(s) in UL channel to reception(s) in DL channel delay at a UE side.

As shown in FIG. 4, a BS transmits a transmission (DL Tx) in symbol #0, and the UE receives the transmission (DL Rx) in symbol #0; and then the UE transmits a transmission (UL Tx) in symbol #8, and the BS receives the transmission (UL Rx) in symbol #8. In FIG. 4, it assumes that the propagation delay (“Pd”) is 4 symbols. Since the UE does not know the distance between the satellite and the ground station, the TA calculated by the UE is TA=1.5*Pd=6 symbols, which causes the UE transmits a transmission (UL Tx) late and the BS receives the transmission (UL Rx) late. Furthermore, the BS receives the transmission (UL Rx) in symbol #8 and transmits a next transmission (DL Tx) in symbol #13, and there is a misalignment at the DL channel and the UL channel (“Misalignment at DL and UL” as shown in FIG. 4) at the BS that is, UL Rx is delayed 2 symbols with respect to DL Tx. Therefore, the transparent payload may impact the UL to DL timing relationship, such as the MAC CE activation delay. Thus the misalignment may impact the timing for the UE to monitor a reception on the DL channel after a transmission on the UL channel. For example, in FIG. 4, the UL to DL delay is 5 symbols with 3 symbols processing delay and 2 symbols misalignment.

However, there is no technical solution on how to indicate to a UE the UL to DL timing relationship (U to D delay) for transparent payload due to the misalignment between DL Tx and UL Rx at a BS side.

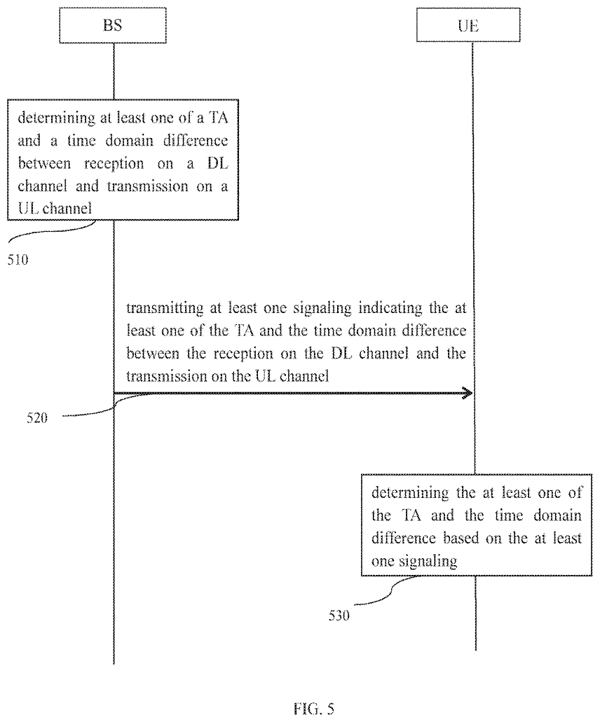

FIG. 5 is a flow chart illustrating an exemplary method for delay indication in a NTN network according to embodiments of the present application.

As shown in FIG. 5, in step 510, a BS (e.g., the satellite 120 in FIG. 1) determines at least one of a TA and a time domain difference between reception on a DL channel and transmission on a UL channel.

In an example, the transmission on the UL channel is after the reception on the DL channel, and the TA and the time domain difference is associated with a specific reference point of multiple reference points. The TA or the time domain difference is one value or multiple values shared by multiple UEs. In the case that the TA or the time domain difference is the multiple values, one of the multiple values may be further indicated e.g., by the BS.

In another example, the reception on the DL channel is after the transmission on the UL channel at a user equipment side. The time domain difference between UL transmission and DL reception at UE side may be based on the misalignment between transmission(s) in the DL channel and reception(s) in the UL channel at a base station side.

In step 520, the BS transmits at least one signaling indicating the at least one of the TA and the time domain difference between the reception on the DL channel and the transmission on the UL channel to a UE (e.g., UE 110 in FIG. 1).

After receiving the signaling, in step 530, the UE determines the at least one of the TA and the time domain difference based on the received signaling.

The following will describe some embodiments of the present application in detail.

Some embodiments of the present application concern on how to indicate to a UE at least one of the scheduling delay, feedback delay and TA corresponding to multiple reference points. The scheduling delay may indicate a delay between PDCCH and PUSCH, and the PUSCH is after the PDCCH. The feedback delay may indicate a delay between PDSCH and PUCCH, and the PUCCH is after the PDSCH. In some cases, the time domain difference may indicate the scheduling delay; in some cases, the time domain difference may indicate the feedback delay; and in some other cases the time domain difference may indicate both of them. The time domain difference (the scheduling delay or the feedback delay) or the TA may be one value or multiple values shared by multiple UEs. In case that the TA or the time domain difference is multiple values, one of the multiple values may be further indicated, which will be described in detail. The multiple values may be associated with multiple reference points.

The time domain difference (the scheduling delay or the feedback delay) can be represented as: D_total=k_offset_common+D_reference_point+K1. Where K_offset_common can be common for a beam, which is defined in the legacy 3GPP release and will not be described in detail. D_reference_point is UE specific, and updated in a large time scale. D_reference_point may be also written as D_referencepoint. K1 is dynamically indicated by UE-specific DCI, which is also defined in the legacy 3GPP release and will not be described in detail.

The TA for UL transmission can be represented as: TA_total=TA_common_per_beam+TA_offset_reference_point+TA_UE. Where TA_common_per_beam is indicated in a beam specific way or a cell specific way. TA_offset_reference_point, and updated in a large time scale. In most cases, TA_offset_reference_point is the same as D_reference_point. TA_UE is the legacy TA indication, which is defined in the legacy 3GPP release and will not be described in detail either.

In some embodiments of the present application, the time domain difference (the scheduling delay or the feedback delay) or the TA associated with a specific reference point of the multiple reference points may be indicated in various ways, which will be described in conjunction with the following detailed embodiments of present application.

In an embodiment of the present application, the time domain difference (e.g., the scheduling delay or the feedback delay) or the TA associated with a specific reference point of the multiple reference points may be indicated by at least one of RRC signaling and MAC CE signaling.

In an example, the time domain difference (the scheduling delay or the feedback delay) or the TA associated with a specific reference point of the multiple reference points may be indicated by RRC signaling in a UE specific way.

In another example, the time domain difference (the scheduling delay or the feedback delay) or the TA associated with a specific reference point of the multiple reference points may be indicated by MAC CE signaling.

In yet another example, the time domain difference (the scheduling delay or the feedback delay) or the TA associated with a specific reference point of the multiple reference points may be indicated by RRC signaling and MAC CE signaling. For example, the RRC signaling may configure multiple feedback delays associated with multiple reference points, and the MAC CE signaling may activate one feedback delay associated with a reference point.

TABLE 1

| R | Serving Cell Index | | | | | BWP Index | |
|---|---|---|---|---|---|---|---|
| C₇ | C₆ | C₅ | C₄ | C₃ | C₂ | C₁ | C₀ |

Table 1 illustrates an example of a MAC CE command. In the table, R indicates a field, the serving cell index indicates a serving cell, the BWP index indicates a BWP, and Ci (i=0, 1 . . . 7) indicates an active status for the time domain difference (the scheduling delay or the feedback delay) or the TA corresponding to the (i+1)-th reference point. For example, when C4 is 1, and other elements are 0, that means the value corresponding to the specific reference point associated with C4 will be used.

In another embodiment of the present application, the time domain difference (the scheduling delay or the feedback delay) or the TA associated with a specific reference point of the multiple reference points may be indicated by a group common DCI for a specific UE. For example, a specific payload position can be configured by RRC signaling for each UE. The specific payload position indicates a position of the delay or the TA for the specific UE in the DCI.

In another embodiment of the present application, the time domain difference (the scheduling delay or the feedback delay) or the TA associated with a specific reference point of the multiple reference points may be indicated by a UE specific DCI. In particular, a list of multiple feedback delays or feedback delays or the TAs associated with multiple reference points can be configured by at least one of RRC signaling and MAC CE signaling, and then a value may be indicated by the UE specific DCI from the list.

In an example, the time domain difference (the scheduling delay or the feedback delay) or the TA associated with a specific reference point of the multiple reference points may be indicated by at least one added bit in the UE specific DCI compared with legacy UE specific DCI. For example, 2 bits in DCI scheduling PDSCH or PUSCH are used to indicate one of four delays or TAs, and each of the delay or TA is associated with a reference point.

In another example, the time domain difference (e.g., the scheduling delay) or the TA associated with a specific reference point of the multiple reference points may be indicated by using time domain resource assignment field in the UE specific DCI. In this case, the time domain difference or TA is jointly encoded with K2. That is, the time domain resource assignment field in the current DCI can be reused in this example of the present application. K2 is a slot delay between PDCCH and PUSCH.

In particular, the time domain resource assignment field in the DCI may indicate a value, and K2 may be obtained by looking up a corresponding table. Thus the delay or TA will be obtained based on K2. Currently, K2=j, j+1, j+2, j+3, where j=1, 2, 3 indicated by PUSCH numerology. K2 is jointly encoded with S, L, and the PUSCH mapping type, and is represented by using 4 bits. S is a start position of PUSCH, and L is a length of PUSCH.

For example, with jointly encoding of K2 and the scheduling delay or the TA, when K2=j+2, j+3, the actual K2 is j, j+1, respectively and the scheduling delay or the TA is the value associated with a reference point, e.g., R1; and when K2=j, j+1, the actual K2 value is j and j+1 respectively, and the scheduling delay or the TA is the value associated with another reference point, e.g., R0. That is, in this example, K2 has four values, and are divided two groups, that is, K2=j, j+1 is associated with reference point R0 and the K2=j+2, j+3 is associated with reference point R1.

In another example, the time domain difference (e.g., the feedback delay) or the TA associated with a specific reference point of the multiple reference points may be indicated by using PUSCH to hybrid automatic repeat request (HARQ) feedback timing indicator in the UE specific DCI. In this case, the time domain difference or TA is jointly encoded with K1. That is, the PDSCH to HARQ feedback timing indicator in the current DCI can be used in this example of the present application.

K1 is a slot delay between PUSCH and PUCCH. As discussed above, K1 is indicated by UE-specific DCI dynamically. Currently, K1 can be at most configured to be 3 bits. For DCI 1-0 format, K1 is one value selected from 0-7; for DCI 1-1 format, K1 is one value selected from −1 to 15; and for DCI 1-2 format, K1 is one value selected from 0-15.

For example, after jointly encoding, when K1 is to be selected from 1st to 4th value configured by RRC signaling, the feedback delay or the TA is associated with a reference point, e.g., R0, and when K1 is to be selected from 5th and 8th value configured by RRC signaling, the feedback delay or the TA is associated with another reference point, e.g., R1.

In another embodiment of the present application, there is an implicit association between the time domain difference (the scheduling delay or the feedback delay) or the TA and RACH resource, and the time domain difference or TA is associated with a specific reference point of the multiple reference points.

The mapping (or association) relationship between the time domain difference (the scheduling delay or the feedback delay) or the TA associated with a specific reference point and RACH resource is configured by broadcast or by RRC signaling by the BS. The RACH resource can be a time domain resource, frequency domain resource, or code domain resource. In an example, the RACH resource is a time domain resource. When the RACH resource at this time is associated with the time domain difference or the TA of a reference point, e.g., R0, the next RACH resource is associated with the time domain difference or the TA of a next reference point, e.g., R1.

In an example, the UE reports the time domain difference (the scheduling delay or the feedback delay) or the TA associated with a specific reference point of the multiple reference points to the BS by selecting RACH resource(s) for PRACH transmission.

In another example, a BS may indicate the time domain difference (the scheduling delay or the feedback delay) or the TA associated with a specific reference point of the multiple reference points by using a PRACH mask index in a UE specific DCI to determine RACH resource configuration. The PRACH mask index indicates a RACH resource, and the UE may know the time domain difference or the TA corresponding to the RACH resource according to the mapping relationship between the time domain difference or the TA associated with a specific reference point and the RACH resource.

The following describes an applicable case of PDCCH triggered PRACH transmission according to embodiments of the present application:
When a random access procedure is initiated by a PDCCH order, the UE, when requested by higher layers, transmits a PRACH in the selected PRACH occasion, as described in [11, TS 38.321], for which a time between the last symbol of the PDCCH order reception and the first symbol of the PRACH transmission is larger than or equal to N_{T,2}+Δ_{BWPSwitching}+Δ_{Delay}+T_{switch}+D_{_referncepoint}+K_offset_common msec, where
   N_{T,2} is a time duration of N₂ symbols corresponding to a PUSCH preparation time for UE processing capability 1 [6, TS 38.214] assuming μ corresponds to the smallest subcarrier spacing (SCS) configuration between the SCS configuration of the PDCCH order and the SCS configuration of the corresponding PRACH transmission
   Δ_{BWPSwitching}=0 when the active BWP does not change and Δ_{BWPSwitching} is defined in [10, TS 38.133] otherwise
   Δ_{Delay}=0.5 msec for FR1 and Δ_{Delay}=0.25 msec for FR2
   T_{switch} is a switching gap duration as defined in [6, TS 38.214]
   D_referencepoint depends on the PRACH Mask index indicated by PDCCH order
   K_offset_common is the scheduling/feedback delay common for a cell/beam.
For a PRACH transmission using 1.25 kHz or 5 kHz SCS, the UE determines N₂ assuming SCS configuration μ=0.

For the case of PDCCH triggered PRACH transmission, in another example, there is a default value for D_referencepoint, so the D_referencepoint in the formula can be deleted. For example, the default value may be 0 or maximum (max) RTD difference in the cell or beam coverage area.

In another embodiment of the present application, the time domain difference (the scheduling delay or the feedback delay) or the TA associated with a specific reference point of the multiple reference points may be indicated by using TA command in random access response (RAR) or MAC CE signaling by a BS. That is, “TA command” is used in RAR or MAC CE signaling in the embodiment of the present application.

In particular, some of most significant bit (MSB) or least significant bit (LSB) of TA command is used to indicate the TA (or the time domain difference) associated with a specific reference point of the multiple reference points, and the remaining LSBs or MSBs are used to indicate the actual UE-specific TA value (that is, TA_UE as discussed above) or the actual UE-specific time domain difference. The mapping relationship between the remaining LSBs and the actual UE-specific TA value or the actual UE-specific time domain difference can be further updated or scaled.

Currently, for TA command in RAR, the possible index are T_A=0, 1, 2, . . . 3846, and for TA command in MAC CE, the possible index are T_A=0, 1, 2, . . . 63.

For example, when 1 MSB of TA command in MAC CE is used to indicate the time domain difference or the TA associated with a specific reference point, and when T_A is from 32 to 63, the time domain difference or the TA is associated with a reference point, e.g., R1, and the actual T_A is 0 to 31 respectively. When T_A is from 0 to 31, the time domain difference or the TA is associated with a reference point, e.g., R0, and the actual T_A is 0 to 31 respectively. When the mapping between remaining LSBs and T_A value is further updated, then the mapping may be updated to N_TA_new=N_TA_old+(TA−31)*16*64/2\hat{ }u*4.

In another example, when 1 LSB of TA command in MAC CE is used to indicate the time domain difference or the TA associated with a specific reference point, and when T_A is 0, 2, 4, 6 . . . , the time domain difference or the TA is associated with a reference point, e.g., R0; otherwise, if the T_A is 1, 3, 5, 7, the time domain difference or the TA is associated with another reference point, e.g., R1.

Although the above examples or embodiments of the present application are described with respect to the time domain difference or the TA associated with a specific reference point of multiple reference points shared by multiple UEs, it should be understood that the above examples or embodiments are also applicable when there is only the time domain difference or the TA associated with one reference point shared by multiple UEs.

In an embodiment of the present application, the time domain difference (the scheduling delay or the feedback delay) or the TA associated with a specific reference point may be predefined or broadcasted in SIB.

There are some time durations predefined in the 3GPP specification which needs to be updated based on the RTD between UE and a satellite.

In an example, the predefined time domain difference (the scheduling delay or the feedback delay) or the TA associated with a reference point may be applied to the time domain difference between 2-step RACH RAR and PUCCH transmission, and the related description in the specification may be updated as follows:
If the UE detects the DCI format 1_0, with cyclic redundancy check (CRC) scrambled by the corresponding MsgB-radio network temporary identifier (RNTI) and LSBs of a (SFN) field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer.
   an uplink grant if the RAR message(s) is for fallbackRAR and a random access preamble identity (RAPID) associated with the PRACH transmission is identified, and the UE procedure continues as described in Clauses 8.2, 8.3, and 8.4 when the UE detects a RAR UL grant, or
   transmission of a PUCCH with HARQ-ACK information having ACK value if the RAR message(s) is for successRAR, where
      a PUCCH resource for the transmission of the PUCCH is indicated by PUCCH resource indicator field of 4 bits in the successRAR from a PUCCH resource set that is provided by pucch-ResourceCommon
      a slot for the PUCCH transmission is indicated by a PDSCH-to-HARQ_feedback timing indicator field of 3 bits in the successRAR having a value k from {1, 2, 3, 4, 5, 6, 7, 8} and, with reference to slots for PUCCH transmission having duration Tₛₗₒₜ, the slot is determined as n+k+Δ, where n is a slot of the PDSCH reception and Δ as defined for PUSCH transmission in Table 6.1.2.1.1-5 of [6, TS 38.214]
      the UE does not expect the first symbol of the PUCCH transmission to be after the last symbol of the PDSCH reception by a time smaller than N_{T,1}+0.5 msec+D_{_referncepoint}+K_offset_common, where N_{T,1} is the PDSCH processing time for UE processing capability 1 [6, TS 38.214], K_offset_common is the scheduling or feedback delay common for a cell or beam. D_referencepoint is associated with a reference point. In a certain case, D_referencepoint is a default value. For example, D_referencepoint may be 0 or max RTD difference in the cell or beam coverage area. In another example, the updates can be based on K_offset_common only with N_{T,1}+0.5 msec+K_offset_common.
      for operation with shared spectrum channel access, a channel access type and CP extension [15, TS 37.213] for a PUCCH transmission is indicated by a ChannelAccess-CPext field in the successRAR
      the PUCCH transmission is with a same spatial domain transmission filter and in a same active UL BWP as a last PUSCH transmission.

In another example, the predefined time domain difference (the scheduling delay or the feedback delay) or the TA associated with a reference point may be applied to a time duration between RACH retransmissions, and the related description may be updated as follows:
The UE does not expect to be indicated to transmit the PUCCH with the HARQ-ACK information at a time that is prior to a time when the UE applies a TA command that is provided by the transport block. If the UE does not detect the DCI format 1_0 with CRC scrambled by the corresponding MsgB-RNTI within the window, or if the UE detects the DCI format 1_0 with CRC scrambled by the corresponding MsgB-RNTI within the window and LSBs of a SFN field in the DCI format 1_0, if applicable, are not same as corresponding LSBs of the SFN where the UE transmitted the PRACH, or if the UE does not correctly receive the transport block in the corresponding PDSCH within the window, or if the higher layers do not identify the RAPID associated with the MACH transmission from the UE, the higher layers can indicate to the physical layer to transmit only PRACH according to Type-1 random access procedure or to transmit both PRACH and PUSCH according to Type-2 random access procedure [11, TS 38.321]. If requested by higher layers, the UE is expected to transmit a PRACH no later than N_{T,1}+0.75 msec+D_{_referncepoint}+K_offset_common after the last symbol of the window, or the last symbol of the PDSCH reception, where N_{T,1} is a time duration of N₁ symbols corresponding to a PDSCH processing time for UE processing capability 1 when additional PDSCH DM-RS is configured. For μ=0, the UE assumes N_{1,0}=14 [6, TS 38.214]. K_offset_common is the scheduling or feedback delay common for a cell or beam. D_referencepoint is associated with a reference point. In a certain case, D_referencepoint is a default value. For example, D_referencepoint may be 0 or max RTD difference in the cell or beam coverage area. In another example, the updates can be based on K_offset_common only with N_{T,1}+0.75 msec+K_offset_common.

In another example, the time domain difference (the scheduling delay or the feedback delay) or the TA associated with a predefined reference point may be applied to a minimum time between Msg.B RAR and PUSCH transmission, and the related description may be updated as follows:
The UE may assume a minimum time between the last symbol of a PDSCH reception conveying a RAR message with a RAR UL grant and the first symbol of a corresponding PUSCH transmission scheduled by the RAR UL grant is equal to N_{T,1}+N_{T,2}+0.5 msec+D_{_referncepoint}+K_offset_common, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 [6, TS 38.214] and, for determining the minimum time, the UE considers that N₁ and N₂ correspond to the smaller of the SCS configurations for the PDSCH and the PUSCH. For μ=0, the UE assumes N_{1,0}=14 [6, TS 38.214]. K_offset_common is the scheduling or feedback delay common for a cell or beam. D_referencepoint is associated with a reference point. In a certain case, D_referencepoint is a default value. For example, D_referencepoint may be 0 or max RTD difference in the cell or beam coverage area. In another example, the updates can be based on K_offset_common only with N_{T,1}+N_{T,2}+0.5 msec+K_offset_common.

In another example, the predefined time domain difference (the scheduling delay or the feedback delay) or the TA associated with a reference point may be applied to a minimum time between Msg.4 RAR and PUCCH, and the related description may be updated as follows:
In response to a PUSCH transmission scheduled by a RAR UL grant when a UE has not been provided a C-RNTI, the UE attempts to detect a DCI format 1_0 with CRC scrambled by a corresponding TC-RNTI scheduling a PDSCH that includes a UE contention resolution identity [11, TS 38.321]. In response to the PDSCH reception with the UE contention resolution identity, the UE transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec+D_{_referncepoint}+K_offset_common. N_{T,1} is a time duration of N₁ symbols corresponding to a PDSCH processing time for UE processing capability 1 when additional PDSCH DM-RS is configured. For μ=0, the UE assumes N_{1,0}=14 [6, TS 38.214]. K_offset_common is the scheduling or feedback delay common for a cell or beam. D_referencepoint is associated with a reference point. In a certain case, D_referencepoint is a default value. For example, D_referencepoint may be 0 or max RTD difference in the cell or beam coverage area. In another example, the updates can be based on K_offset_common only with N_{T,1}+0.5 msec+K_offset_common.

In another example, the time domain difference (the scheduling delay or the feedback delay) or the TA associated with a predefined reference point may be applied to a gap between non-zero power channel state information-reference signal (NZP CSI-RS) and sounding reference signal (SRS) for non-codebook based PUSCH transmission, and the related description may be updated as follows:
For non-codebook based transmission, the UE can calculate the precoder used for the transmission of SRS based on measurement of an associated NZP CSI-RS resource. A UE can be configured with only one NZP CSI-RS resource for the SRS resource set with higher layer parameter usage in SRS-ResourceSet set to ‘nonCodebook’ if configured.
   If aperiodic SRS resource set is configured, the associated NZP-CSI-RS is indicated via SRS request field in DCI format 0_1 and 1_1, as well as DCI format 0_2 (if SRS request field is present) and DCI format 1_2 (if SRS request field is present), where AperiodicSRS-ResourceTrigger and AperiodicSRS-ResourceTriggerList (indicating the association between aperiodic SRS triggering state(s) and SRS resource sets), triggered SRS resource(s) srs-ResourceSetId, csi-RS (indicating the associated NZP-CSI-RS-ResourceId) are higher layer configured in SRS-ResourceSet. The SRS-ResourceSet(s) associated with the SRS request by DCI format 0_1 and 1_1 are defined by the entries of the higher layer parameter srs-ResourceSetToAddModList and the SRS-ResourceSet(s) associated with the SRS request by DCI format 0_2 and 1_2 are defined by the entries of the higher layer parameter srs-ResourceSetToAddModList-ForDCIFormat0_2. A UE is not expected to update the SRS precoding information if the gap from the last symbol of the reception of the aperiodic NZP-CSI-RS resource and the first symbol of the aperiodic SRS transmission is less than 42 OFDM symbols+D_{_referncepoint}+K_offset_common. Where K_offset_common is the scheduling/feedback delay common for a cell/beam. D_referencepoint is associated with a reference point. In a certain case, D_referencepoint is a default value. For example, D_referencepoint may be 0 or max RTD difference in the cell or beam coverage area. In another example, the updates can be based on K_offset_common only with 42 OFDM symbols+K_offset_common.
   If the UE configured with aperiodic SRS associated with aperiodic NZP CSI-RS resource, the presence of the associated CSI-RS is indicated by the SRS request field if the value of the SRS request field is not ‘00’ as in Table 7.3.1.1.2-24 of [5, TS 38.212] and if the scheduling DCI is not used for cross carrier or cross bandwidth part scheduling. The CSI-RS is located in the same slot as the SRS request field. If the UE configured with aperiodic SRS associated with aperiodic NZP CSI-RS resource, any of the TCI states configured in the scheduled CC shall not be configured with ‘QCL-TypeD’.
   If periodic or semi-persistent SRS resource set is configured, the NZP-CSI-RS-ResourceId for measurement is indicated via higher layer parameter associatedCSI-RS in SRS-ResourceSet.

Some embodiments of the present application concern on how to indicate to a UE the UL to DL timing relationship (U to D delay) for transparent payload due to misalignment between DL Tx and UL Rx at a BS side. A reception on the DL channel is after a transmission on the UL channel at a UE side. According to some embodiments of the present application, the signaling indicates at least one value and is based on misalignment between transmission(s) in the DL channel and reception(s) in the UL channel at a base station side, and the reception on the DL channel is after the transmission on the UL channel at a user equipment side. The at least one value can be referred to as “misalignment value” hereafter.

The misalignment value between DL Tx and UL Rx at the BS side should be known to UE(s) for DL channel or reference signal (RS) reception or application. The misalignment value is adopted for RRC connected state with a valid TA. It is applied after the UL Tx timing is already advanced by the TA indication, and it is different from the absolute delay value adopted for RRC idle state (e.g. delay between PRACH and RAR).

In an embodiment, the misalignment value can be indicated by a single value. In another embodiment, the misalignment value can be indicated by an initial value and a rate, the rate is a change rate dependent on time of the initial value. In an example, the rate may correspond to the selection of a ground station and a moving velocity of a satellite. The misalignment value can be in unit of ms or in unit of slot or symbol. When it is in unit of slot or symbol, a reference subcarrier spacing (SCS) should be determined or indicated. For example, the SCS may be determined based on the same SCS as that to determine the symbol/slot duration for the corresponding 4/1 symbol for monitoring PDCCH.

The signaling for indicating the misalignment value can be in a cell specific way or UE specific way. The misalignment value can be broadcasted or indicated in SIB, or configured by RRC signaling or MAC CE signaling, or configured by group common DCI (for example, the misalignment value can be configured in a payload position in a group common DCI).

The signaling for indicating the misalignment value can be applied to some cases.

In an embodiment of the present application, the signaling for indicating the misalignment value can be applied to MAC CE activation delay. The delay indicates the delay between ACK/NACK (A/N) transmission and application of the MAC CE command at UE side. For example, the current value indicating the U to D delay is 3 ms. In this embodiment, the value indicating the U to D delay will be updated to 3 ms+D_mis, where D_mis is the misalignment value between DL Tx and UL Rx at gNB side, and the related description in the specification may be updated as follows:
For a timing advance command received on uplink slot n and for a transmission other than a PUSCH scheduled by a RAR UL grant or a fallbackRAR UL grant as described in Clause 8.2A or 8.3, or a PUCCH with HARQ-ACK information in response to a successRAR as described in Clause 8.2A, the corresponding adjustment of the uplink transmission timing applies from the beginning of uplink slot n+k+1 where k┌Nₛₗₒₜ^{subframeμ}·(N_{T,1}+N_{T,2}+N_{TA,max}+0.5)/T_{sf}┐+D_mis, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1 [6, TS 38.214], N_{TA,max} is the maximum timing advance value in msec that can be provided by a TA command field of 12 bits, Nₛₗₒₜ^{subframe,μ} is the number of slots per subframe, and T_{sf} is the subframe duration of 1 msec. N₁ and N₂ are determined with respect to the minimum SCS among the SCSs of all configured UL BWPs for all uplink carriers in the TAG and of all configured DL BWPs for the corresponding downlink carriers. For μ=0, the UE assumes N_{1,0}=14 [6, TS 38.214]. Slot n and Nₛₗₒₜ^{subframe,μ} are determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n is the last slot among uplink slot(s) overlapping with the slot(s) of PDSCH reception assuming T_{TA}=0, where the PDSCH provides the timing advance command and T_{TA} is defined in [4, TS 38.211].
With reference to slots for PUCCH transmissions, when a UE receives in a PDSCH an activation command [11, TS 38.321] for a secondary cell ending in slot n, the UE applies the corresponding actions in [11, TS 38.321] no later than the minimum requirement defined in [10, TS 38.133] and no earlier than slot n+k , except for the following:
   the actions related to CSI reporting on a serving cell that is active in slot n+k
   the actions related to the sCellDeactivationTimer associated with the secondary cell [11, TS 38.321] that the UE applies in slot n+k
   the actions related to CSI reporting on a serving cell which is not active in slot n+k that the UE applies in the earliest slot after n+k in which the serving cell is active.
The value of k is k₁+3·Nₛₗₒₜ^{subframe,μ}+1+D_mis, where k₁ is a number of slots for a PUCCH transmission with HARQ-ACK information for the PDSCH reception and is indicated by the PDSCH-to-HARQ_feedback timing indicator field in the DCI format scheduling the PDSCH reception as described in Clause 9.2.3 and Nₛₗₒₜ^{subframe,μ} is a number of slots per subframe for the SCS configuration μ of the PUCCH transmission. D_mis is the misalignment value between DL Tx and UL Rx at gNB side.

In another embodiment of the present application, the signaling for indicating the misalignment value can be applied to time domain duration between beam failure recovery (BFR) PRACH transmission and PDCCH monitoring. In this embodiment, the related description in the specification may be updated as follows:
For the primary cell (PCell) or the primary secondary cell (PSCell), the UE can be provided, by PRACH-ResourceDedicatedBFR, a configuration for PRACH transmission as described in Clause 8.1. For PRACH transmission in slot n and according to antenna port quasi co-location parameters associated with periodic CSI-RS resource configuration or with SS/PBCH block associated with index q_{new} provided by higher layers [11, TS 38.321], the UE monitors PDCCH in a search space set provided by recoverySearchSpaceId for detection of a DCI format with CRC scrambled by C-RNTI or MCS-C-RNTI starting from slot 4 symbols+D_mis within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList. Where D_mis is the misalignment value between DL Tx and UL Rx at gNB side.

In yet another embodiment of the present application, the signaling for indicating the misalignment value can be applied to time domain duration between configured grant based PUSCH transmission and PDCCH monitoring. For example, the current value indicating the U to D delay is 1 symbol. In this embodiment, the value indicating the U to D delay may be updated to 1 symbol+D_mis or cg-minDFIDelay-r16+D_mis, where D_mis is the misalignment value between DL Tx and UL Rx at gNB side, and the related description in the specification may be updated as follows:
A UE can be configured a number of search space sets to monitor PDCCH for detecting a DCI format 0_1 with a DFI flag field and CRC scrambled with a CS-RNTI provided by cs-RNTI. The UE determines that the DCI format provides HARQ-ACK information for PUSCH transmissions when a DFI flag field value is set to ‘1’, if a PUSCH transmission is configured by ConfiguredGrantConfig.
The HARQ-ACK information corresponds to transport blocks in PUSCH transmissions for all HARQ processes for a serving cell of a PDCCH reception that provides DCI format 0_1 or, if DCI format 0_1 includes a carrier indicator field, for a serving cell indicated by a value of the carrier indicator field.
For a PUSCH transmission configured by ConfiguredGrantConfig, HARQ-ACK information for a transport block of a corresponding HARQ process number is valid if a first symbol of the PDCCH reception is after a last symbol of the PUSCH transmission, or of any repetition of the PUSCH transmission, by a number of symbols provided by cg-minDFIDelay-r16+D_mis.
For an initial transmission by a UE of a transport block in a PUSCH configured by ConfiguredGrantConfig, if the UE receives a CG-DFI that provides HARQ-ACK information for the transport block, the UE assumes that the transport block was correctly decoded if the HARQ-ACK information value is ACK; otherwise, the UE assumes that the transport block was not correctly decoded.
For a PUSCH transmission scheduled by a DCI format, HARQ-ACK information for a transport block of a corresponding HARQ process number is valid if a first symbol of the PDCCH reception is after a last symbol of the PUSCH transmission by a number of symbols provided by cg-minDFIDelay-r16+D_mis or, if the PUSCH transmission is over multiple slots, where D_mis is the misalignment value between DL Tx and UL Rx at gNB side.
   after a last symbol of the PUSCH transmission in a first slot from the multiple slots by a number of symbols provided by cg-minDFIDelay-r16+D_mis, if a value of the HARQ-ACK information is ACK.
   after a last symbol of the PUSCH transmission in a last slot from the multiple slots by a number of symbols provided by cg-minDFIDelay-r16+D_mis, if a value of the HARQ-ACK information is NACK.

Therefore, the above described embodiments can at least solve the technical problem concerning on how to indicate to the UE the scheduling delay or the feedback delay and TA corresponding to multiple reference points and how to indicate to the UE a UL to DL timing relationship (U to D delay) for transparent payload due to misalignment between DL Tx and UL Rx at a BS side.

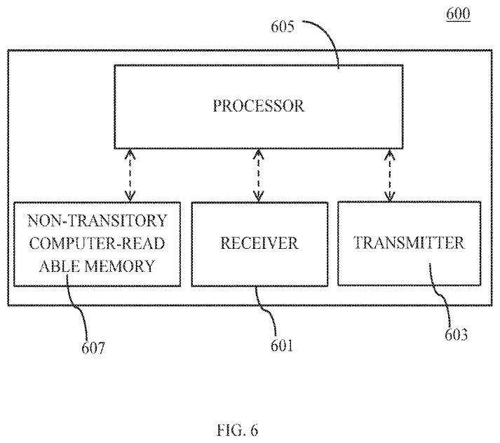

FIG. 6 illustrates an apparatus according to some embodiments of the present application. In some embodiments of the present disclosure, the apparatus 600 may be a UE 110 as illustrated in FIG. 1 or other embodiments of the present application.

As shown in FIG. 6, the apparatus 600 may include a receiver 601, a transmitter 603, a processer 605, and a non-transitory computer-readable medium 607. The non-transitory computer-readable medium 607 has computer executable instructions stored therein. The processer 605 is configured to be coupled to the non-transitory computer readable medium 607, the receiver 601, and the transmitter 603. It is contemplated that the apparatus 600 may include more computer-readable mediums, receiver, transmitter and processors in some other embodiments of the present application according to practical requirements. In some embodiments of the present application, the receiver 601 and the transmitter 603 are integrated into a single device, such as a transceiver. In certain embodiments, the apparatus 600 may further include an input device, a memory, and/or other components.

In some embodiments of the present application, the non-transitory computer-readable medium 607 may have stored thereon computer-executable instructions to cause a processor to implement the method according to embodiments of the present application.

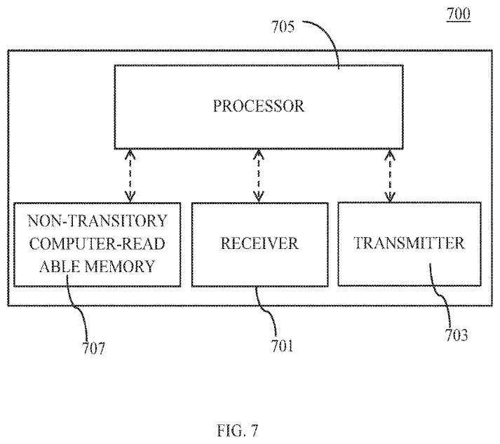

FIG. 7 illustrates an apparatus according to some embodiments of the present application. In some embodiments of the present disclosure, the apparatus 700 may be a BS (e.g., a satellite 120) as illustrated in FIG. 1 or other embodiments of the present application.

As shown in FIG. 7, the apparatus 700 may include a receiver 701, a transmitter 703, a processer 706, and a non-transitory computer-readable medium 707. The non-transitory computer-readable medium 707 has computer executable instructions stored therein. The processer 706 is configured to be coupled to the non-transitory computer readable medium 707, the receiver 701, and the transmitter 703. It is contemplated that the apparatus 700 may include more computer-readable mediums, receiver, transmitter and processors in some other embodiments of the present application according to practical requirements. In some embodiments of the present application, the receiver 701 and the transmitter 703 are integrated into a single device, such as a transceiver. In certain embodiments, the apparatus 700 may further include an input device, a memory, and/or other components.

In some embodiments of the present application, the non-transitory computer-readable medium 707 may have stored thereon computer-executable instructions to cause a processor to implement the method according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

1. A method, comprising:
receiving at least one signaling indicating at least one of a timing advance (TA) or a time domain difference between reception on a downlink (DL) channel and transmission on an uplink (UL) channel; and
determining the at least one of the TA or the time domain difference based on the at least one signaling.

2. The method of claim 1, wherein the transmission on the UL channel is after the reception on the DL channel.

3. The method of claim 1, wherein the TA or the time domain difference is one value or multiple values shared by multiple user equipments (UEs).

4. The method of claim 3, further comprising:
indicating one of the multiple values if the TA or the time domain difference is the multiple values.

5. The method of claim 3, wherein the value or one of the multiple values is indicated by at least one of:
at least one of radio resource control (RRC) signaling or medium access control (MAC) control element (CE) signaling;
a group common downlink control information (DCI);
a UE specific DCI;
at least one added bit in the UE specific DCI compared with legacy UE specific DCI;
using a time domain resource assignment field in the UE specific DCI; or
using physical downlink shared channel (PDSCH) to hybrid automatic repeat request (HARQ) feedback timing indicator in the UE specific DCI.

6-10. (canceled)

11. The method of claim 1, further comprising: receiving a second signaling indicating a relationship between the TA or the time domain difference and a random access channel (RACH) resource.

12-14. (canceled)

15. The method of claim 1, wherein a value of the TA or the time domain difference is at least one of predefined or broadcasted in a system information block (SIB), and wherein the value is applied to at least one of:
the time domain difference between a two-step random access channel (RACH) random access response (RAR) and a physical uplink control channel (PUCCH) transmission;
a time duration between RACH retransmissions;
a minimum time between a Msg.B RAR and a physical uplink shared channel (PUSCH) transmission;
a minimum time between a Msg.4 RAR and the PUCCH transmission; or
a gap between a non-zero power channel state information-reference signal (NZP CSI-RS) and a sounding reference signal (SRS) for a non-codebook based PUSCH transmission.

16-20. (canceled)

21. The method of claim 1, wherein the at least one signaling indicates at least one value and is based on misalignment between one or more transmissions in the DL channel and one or more receptions in the UL channel at a base station and the reception on the DL channel is after the transmission on the UL channel at a user equipment (UE).

22. The method of claim 21, wherein:
the at least one value is indicated by at least one of a system information block; (SIB), a radio resource control (RRC) signaling), a medium access control (MAC) control element (CE) signaling, or a group common downlink control information (DCI); and
wherein the at least one signaling is applied to at least one of:
a MAC CE activation delay;
a first time domain duration between beam failure recovery (BFR) physical random access channel (PRACH) transmission and physical downlink control channel (PDCCH) monitoring; or
a second time domain duration between configured grant based physical uplink shared channel (PUSCH) transmission and the PDCCH monitoring.

23-26. (canceled)

27. An apparatus, comprising:
a receiver;
a transmitter;
a processor coupled to the receiver and the transmitter configured to cause the apparatus to:
determine at least one of a timing advance (TA) or a time domain difference between reception on a downlink (DL) channel and transmission on an uplink (UL) channel; and
transmit at least one signaling indicating the at least one of the TA or the time domain difference between the reception on the DL channel and the transmission on the UL channel.

28. The apparatus of claim 27, wherein the transmission on the UL channel is after the reception on the DL channel.

29. The apparatus of claim 27, wherein the TA or the time domain difference is one value or multiple values shared by multiple user equipments (UEs).

30. (canceled)

31. The apparatus of claim 29, wherein the value or one of the multiple values is indicated by at least one of:
at least one of a radio resource control (RRC) signaling or medium access control (MAC) control element (CE) signaling;
a group common downlink control information (DCI);
a UE specific DCI;
at least one added bit in the UE specific DCI compared with legacy UE specific DCI;
using a time domain resource assignment field in the UE specific DCI; or
using physical downlink shared channel (PDSCH) to hybrid automatic repeat request (HARQ) feedback timing indicator in the UE specific DCI.

32-51. (canceled)

52. An apparatus, comprising:
a receiver;
a transmitter; and
a processor coupled to the receiver and the transmitter configured to cause the apparatus to:
receive at least one signaling indicating at least one of a timing advance (TA) or a time domain difference between reception on a downlink (DL) channel and transmission on an uplink (UL) channel; and
determine the at least one of the TA or the time domain difference based on the at least one signaling.

53. (canceled)

54. The apparatus of claim 52, wherein the transmission on the UL channel is after the reception on the DL channel.

55. The apparatus of claim 52, wherein the TA or the time domain difference is one value or multiple values shared by multiple user equipments (UEs).

56. The apparatus of claim 55, wherein the value or one of the multiple values is indicated by at least one of:
at least one of radio resource control (RRC) signaling or medium access control (MAC) control element (CE) signaling;
a group common downlink control information (DCI);
a UE specific DCI;
at least one added bit in the UE specific DCI compared with legacy UE specific DCI;
using a time domain resource assignment field in the UE specific DCI; or
using physical downlink shared channel (PDSCH) to hybrid automatic repeat request (HARQ) feedback timing indicator in the UE specific DCI.

57. The apparatus of claim 52, wherein the processor coupled to the receiver and the transmitter is configured to cause the apparatus to receive a second signaling indicating a relationship between the TA or the time domain difference and a random access channel (RACH) resource.

58. The apparatus of claim 52, wherein a value of the TA or the time domain difference is at least one of predefined or broadcasted in a system information block (SIB), and wherein the value is applied to at least one of:
the time domain difference between a two-step random access channel (RACH) random access response (RAR) and a physical uplink control channel (PUCCH) transmission;
a time duration between RACH retransmissions;
a minimum time between a Msg.B RAR and a physical uplink shared channel (PUSCH) transmission;
a minimum time between a Msg.4 RAR and the PUCCH transmission; or
a gap between a non-zero power channel state information-reference signal (NZP CSI-RS) and a sounding reference signal (SRS) for a non-codebook based PUSCH transmission.

59. The apparatus of claim 52, wherein the at least one signaling indicates at least one value and is based on misalignment between one or more transmissions in the DL channel and one or more receptions in the UL channel at a base station, and the reception on the DL channel is after the transmission on the UL channel at a user equipment (UE).
